(19) United States
(12) Patent Application Publication
(10) Pub. No.: US 2018/0052696 A1
(43) Pub. Date: Feb. 22, 2018

(54) PROVIDING TEACHING USER INTERFACE ACTIVATED BY USER ACTION

(71) Applicant: MICROSOFT TECHNOLOGY LICENSING, LLC, Redmond, WA (US)

(72) Inventors: Vlad Riscutia, Redmond, WA (US); Alexis Odell, Redmond, WA (US); Michael Navarro, Kirkland, WA (US); Darron Stepanich, Redmond, WA (US)

(73) Assignee: MICROSOFT TECHNOLOGY LICENSING, LLC, Redmond, WA (US)

(21) Appl. No.: 15/241,151

(22) Filed: Aug. 19, 2016

(51) Int. Cl. G06F 9/44; G06N 5/04

(52) U.S. Cl. CPC G06F 9/4443; G06F 17/30424; G06N 5/048

(57) ABSTRACT

A teaching user interface (UI) activated by a user action is provided. A productivity service initiates operations to provide the teaching UI by receiving a notification of a user action from a productivity application. A trait associated with a user who performs the user action is recognized. The trait includes a user identification and/or a context associated with the user, among other things. A content associated with a feature of the productivity application is identified for a presentation in a teaching UI based on the trait and the user action. The content is provided in the teaching UI to instruct the user on how to use the feature of the productivity application.

### BACKGROUND

Information collection, management, and analysis have changed work processes and associated application use. Automation and improvements in work processes have expanded scope of capabilities offered by applications. With the development of faster and smaller electronics, execution of mass processes at client and cloud application systems have become feasible. Indeed, feature deployment at client devices and cloud solutions have become common features in modern application environments. Such solutions provide a wide variety of applications such as productivity applications that present training tools to deploy features. Many such applications present training materials to attempt to improve and optimize utilization. User training and preparation also consume significant resources and performance at a promise of improved processes and condensed task flows affecting utilization of productivity applications.

User training techniques are becoming ever more important as application complexity grows in proportion to processing capacity across the computer industry. Variety of training techniques are necessary for deployment of multiple features that relate to a multitude of user audiences. There are currently significant gaps within training presentation methods employed when dealing with application feature sets. Lack of easy to use training presentation methods lead to underutilization of application features.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing a teaching user interface (UI) activated by a user action. A productivity service, according to embodiments, may initiate operations to provide the teaching UI upon receiving a notification of a user action from a productivity application. The productivity service may also recognize a trait associated with a user performing the user action. A content associated with a feature of the productivity application may be identified for a presentation in a teaching UI based on the trait and the user action. Furthermore, the content may be provided in the teaching UI for a presentation on the productivity application.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating an example of providing a teaching user interface (UI) activated by a user action, according to embodiments;

FIG. 2 is a display diagram illustrating a scheme to provide a teaching UI activated by a user action, according to embodiments;

FIG. 3 is a display diagram illustrating example components of a productivity application that provides a teaching UI activated by a user action, according to embodiments;

FIG. 4 is a display diagram illustrating components of a scheme to provide a teaching UI activated by a user action, according to embodiments;

FIG. 5 is a simplified networked environment, where a system according to embodiments may be implemented;

FIG. 6 is a block diagram of an example computing device, which may be used to provide a teaching UI activated by a user action, according to embodiments; and

FIG. 7 is a logic flow diagram illustrating a process for providing a teaching UI activated by a user action, according to embodiments.

### DETAILED DESCRIPTION

As briefly described above, a productivity service may provide a teaching user interface (UI) activated by a user action. In an example scenario, the productivity service may receive a notification of a user action from a productivity application. The user action may include a workflow which may indicate an intent of the user to activate a feature of the productivity application. The feature may include a previously unused feature, an underutilized feature, and/or a new feature, among others.

The productivity service may recognize a trait associated with the user. The trait may include a user credential, a context associated with the user, and/or similar ones. Next, a content associated with a feature of the productivity application may be identified for a presentation in a teaching UI based on the trait and the user action. The content may include a video stream, an audio stream, and/or a presentation, among others with steps describing how to use the feature. The productivity service may provide the content in the teaching UI for a presentation on the productivity application.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a physical computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components to provide a teaching UI activated by a user action. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

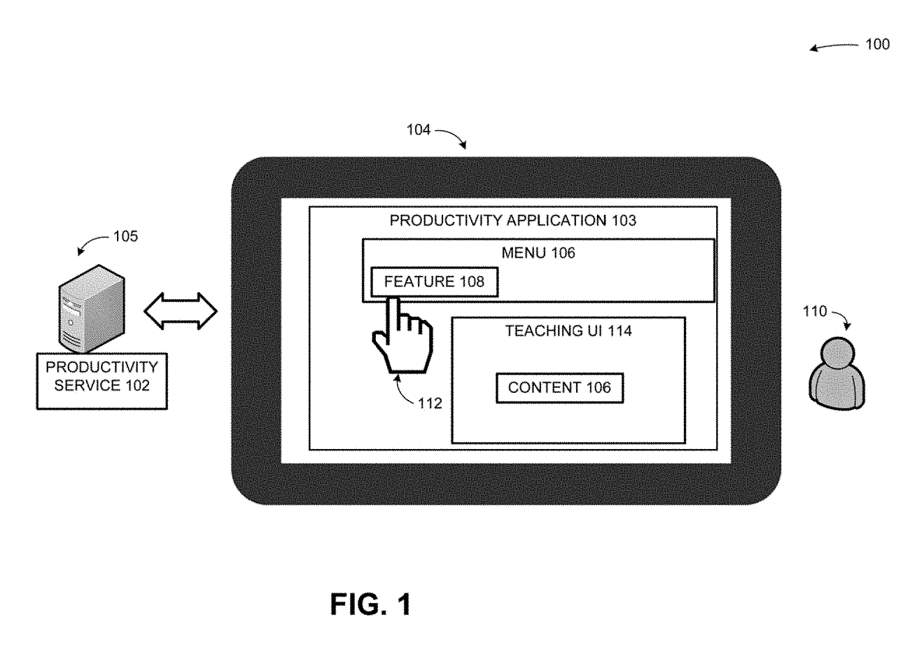

FIG. 1 is a conceptual diagram illustrating examples of providing a teaching UI activated by a user action, according to embodiments.

In a diagram 100, a physical server 106 may execute a productivity service 102. The productivity service 102 may include a cloud based service. The physical server 105 may include a desktop computer, a work station, a data warehouse, a datacenter, and/or similar ones. The physical server 105 may also include a special purpose and/or configured device that is optimized to execute data operations associated with the productivity service 102. For example, the physical server 105 may include physical components that are custom built to accelerate operations associated with a teaching UI.

The physical server 105 may execute the productivity service 102. The productivity service 102 may initiate operations to provide a teaching UI upon receiving a notification of a user action 112 from a productivity application 103 executed on a client device 104. The client device 104 may include a mobile device, a notebook computer, a smartphone, and/or a desktop computer, among others. The user action 112 may include operations to activate a feature 108 within a menu 106 of an application UI of the productivity application 102. The menu 106 may include other features in addition to the feature 108. Each feature may be configured to execute operations to accomplish a task associated with the productivity application 102. The productivity service 102 may prompt the productivity application 103 to activate the teaching UI 114 for a variety of conditions that may involve a detected trait of a user 110 such as previous use patterns associated with the productivity application 102, among others.

The trait of the user may include a credential, a context associated with the user, and/or similar ones. The productivity service 102 may identify a content 116 associated with the feature 108 for a presentation in the teaching UI 114. The content 116 may include a video stream, an audio stream, a presentation, and/or similar ones that describe how to use the feature 108 to the user 110. The content 116 may be provided for a presentation in the teaching UI 114 to the productivity application 103. The productivity service 102 may generate the teaching UI 114 and provide the content 116 within the teaching UI for rendering by the productivity application 103.

For example, the productivity service 102 may receive a notification of the user action 112 from the productivity application 103. The user action may include two or more steps that the user 110 may execute to accomplish a task in the productivity application 103. The productivity service 102 may match the user action and other traits such as the two or steps to a feature 108 of the productivity application 103 that may accomplish the task in one step. The productivity service 102 may identify a content associated with the productivity service and provide the content to the productivity application 103 for a presentation to the user 110 to show how to use the feature 108.

The physical server 105 may communicate with the client device 104 and other client device(s) or server(s) through a network. The network may provide wired or wireless communications between network nodes such as the computing device 104, other client device(s) and/or server(s), among others. Previous example(s) to provide the teaching UI 114 activated by the user action 112 are not provided in a limiting sense. Alternatively, the productivity application 103 may be provided as a client interface of the productivity service 102. In another scenario, the productivity application 103 may process the user action to identify the content 106 and present the content 106 on the teaching UI. In yet another scenario, the teaching UI 114 may be provided to a client application which interacts with the user 110 through other client devices such as a smartphone, among others.

The user 110 may interact with the productivity application 102 with a keyboard based input, a mouse based input, a voice based input, a pen based input, and a gesture based input, among others. The gesture based input may include one or more touch based actions such as a touch action, a swipe action, and a combination of each, among others.

While the example system in FIG. 1 has been described with specific components including the physical server 105, the productivity service 102, embodiments are not limited to these components or system configurations and can be implemented with other system configuration employing fewer or additional components.

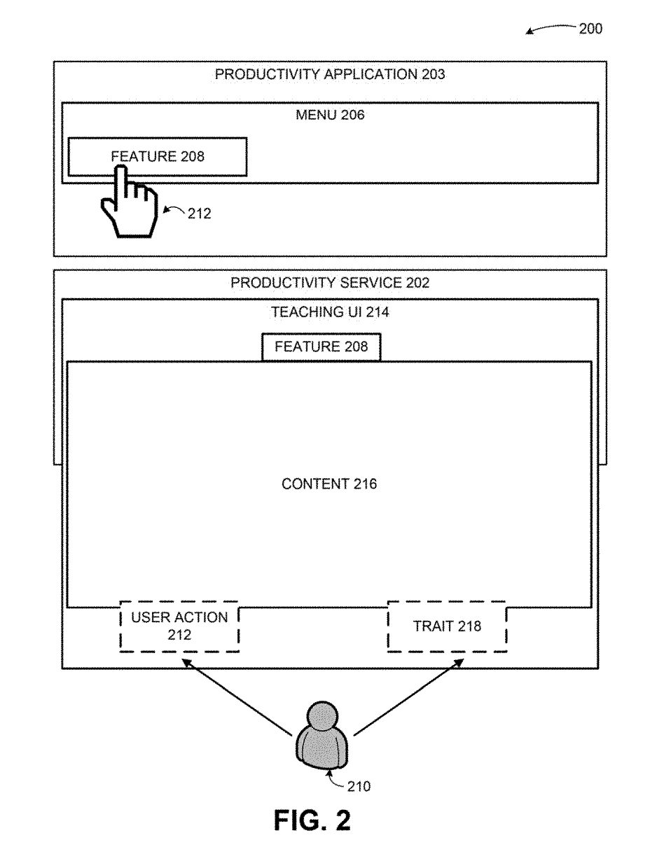

FIG. 2 is a display diagram illustrating a scheme to provide a teaching UI activated by a user action, according to embodiments.

In a diagram 200, a productivity application 203 may display application UT components such as a menu 206 that may provide components that execute operations. An example of a component may include a feature 208. The feature 208 may include an existing feature or a new feature. Use patterns by the user 210 may be analyzed by a productivity service 202 to determine an underutilization or a failure to use the feature 208. In such a scenario, a user action 212 may be analyzed in relation to the feature 208 by the productivity service 202. The productivity service 202 may prompt the productivity application 203 to present a teaching UI 214 to render content describing how to use the feature 208.

The productivity service 202 may provide the teaching UI 214 (to the productivity application 203) for a presentation a content 216 associated with the feature 208. The content 216 may include instructions to teach the user 210 how to use the feature 208. The content 216 may include a video stream, an audio stream, a presentation, and/or similar ones with steps to illustrate utilization of the feature 208. A trait 218 of the user and the user action 212 may be used to identify the content 216. The trait 218 may include a credential of the user 210 and/or a context associated with the user 210. The credential may be used to access information providers such as an organizational service to receive historical information associated with the user 210 such as use patterns of the productivity application 202. The user patterns may be analyzed to detect a failure to use or underutilization of the feature 208.

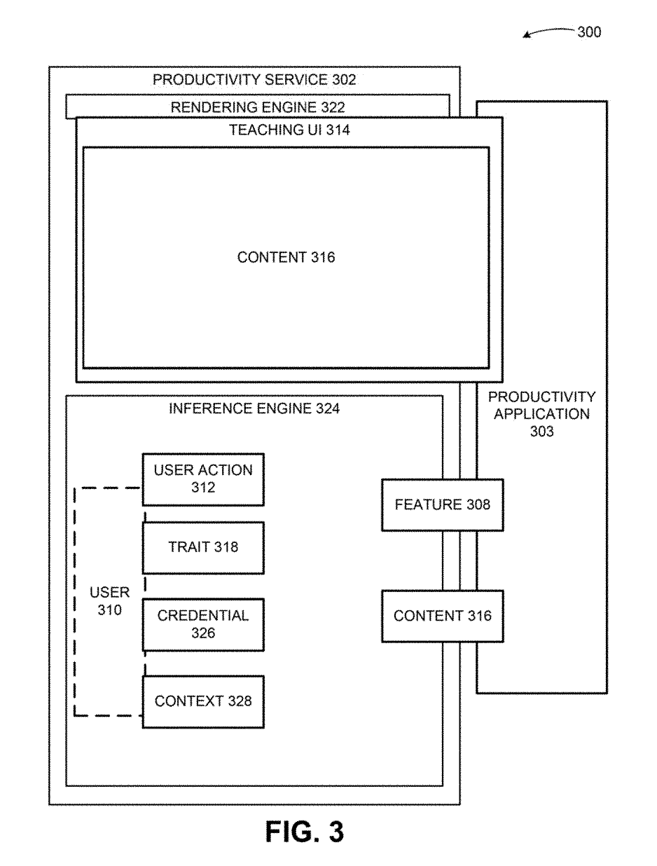

FIG. 3 is a display diagram illustrating example components of a productivity application that provides a teaching UI activated by a user action, according to embodiments.

In a diagram 300, an inference engine 324 of a productivity service 302 may process a user action 312 (received from a productivity application 303) and a trait 318 of a user 310 to identify a content 316 associated with a feature 308. The content 316 may include an illustration of how to use the feature 308. The content 316 may be provided to the user 310 by a rendering engine 322 within a teaching UI 314.

The teaching UI 314 may include controls to display the content 316 which may include a video stream, an audio stream, a presentation, and/or similar ones that describe how to use the feature. The content 316 may include steps to instruct the user 310. The content 316 may be provided dynamically in response to the user action 312. As such, training the user 310 on how to use the feature 308 may be automated by providing the content 316 on demand in response to the user action 312. The demand for the content 316 may be determined by the inference engine 324 based on an analysis of various factors including a user intent, and/or use history, among others associated with the productivity application 303 and the feature 308 rendered by the productivity application 303.

In an example scenario, the inference engine 324 may identify a credential 326 as a trait 318 of the user 310. The inference engine 324 may query a provider with the credential 326 for a context 328 associated with the user 310. The context 328 may include a role of the user within an organization, an expertise of the user with the productivity application 302, a training history of the user with the productivity application 302, and/or a utilization history of the user with the productivity application, among others. An example of the provider may include a component of the productivity service 302, an external entity such as an organizational provider, a networking provider, and/or similar ones. For example, the inference engine 324 may query the provider to receive a training history of the user 310 in relation to the feature 308 presented on the productivity application 303. Upon analysis of the training history, the inference engine 324 may determine that the user 310 was not exposed to training associated with the feature 308. In such a scenario, the content 316 that describes how to use the feature 308 may be presented to the user 310 on the teaching UT 314.

Alternatively, a role of the user 310 (such as a supervisor) may be identified as the context 328 associated with the user 310. An organization associated with the user 310 may have rule(s) that mandate any user with the role to receive training on the feature 308. The user action 312 may be analyzed to detect that the user 310 lacks training on how to use the feature 308 (based on a detected work flow that evades the feature 308). In such a scenario, the inference engine 324 may search and locate the content 316 that matches the context associated with the user 310. For example, the inference engine 324 may customize the content 316 to highlight sections of the content 316 that address users lack of training on the feature 308.

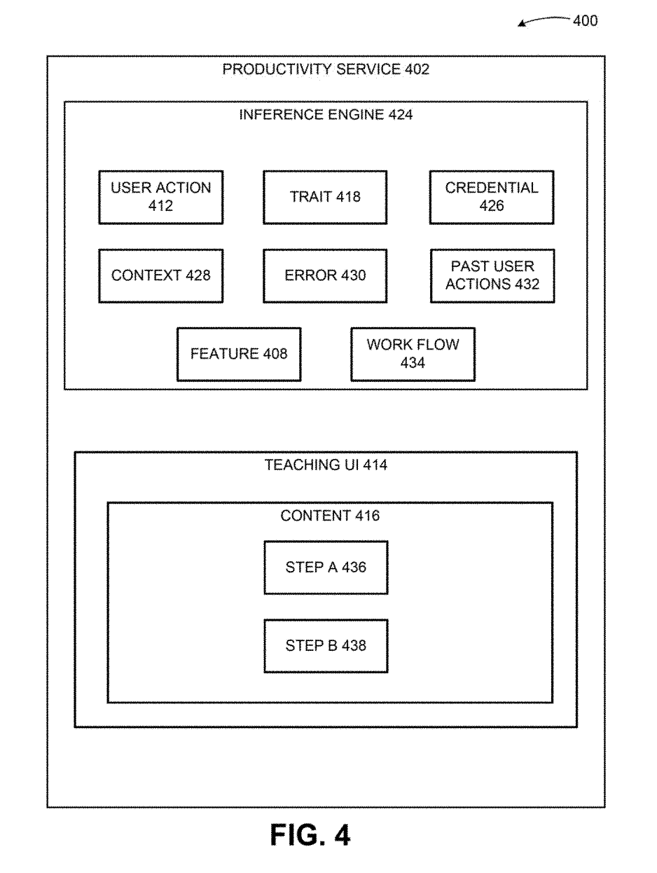

FIG. 4 is a display diagram illustrating components of a scheme to provide a teaching UI activated by a user action, according to embodiments.

In a diagram 400, an inference engine 424 of a productivity service 4012 may identify a content 416 associated with a feature 408 presented on a productivity application. The feature 408 may be a component of the productivity application. Alternatively, the feature 408 may be provided to the productivity application by the productivity service 402. The content 416 may be presented to a user in a teaching UI 414 to train the user on how to use the feature 408.

In an example scenario, the inference engine 424 may identify a trait 418 of the user. The trait 418 may be used to identify the content when searching for the content based on the trait and the user action. For example, a credential 426 of the user may be identified as the trait 418 of the user. The credential 426 may be used to retrieve a use history of the productivity application by the user. The use history may include past user actions 432 associated with the productivity application (and/or other productivity applications). The inference engine 424 may analyze the use history to identify the feature 408 of the productivity application underutilized or unused by the user. The content 416 that matches the feature 408 may be identified and presented to the user to enhance a utilization of the feature 408 by the user.

The inference engine 424 may also analyze the user action 412 to detect an intent of the user to active the feature 408. In such a scenario, the content 416 (that matches the feature 408) may be automatically searched, located, and presented to the user through the teaching UI 414. Instead of an automated presentation, the inference engine 424 may also analyze a use history (such as the past user actions 432) associated with the feature 408 to detect an underutilization or a failure to use the feature 408 (by the user). As a result, the content 416 may be provided for a presentation to the user through the teaching UI 414.

Furthermore, the inference engine 424 may analyze the user action 412 to detect a workflow 434 of the user. The workflow 434 may describe one or more operations and an intent of the user while executing the user action 412. The workflow 434 may also be detected to have an association with the feature 408. For example, the user may execute a series of operations that are related to the feature 408. In such a scenario, the inference engine 424 may infer that the user may intend to activate the feature 408 based on the workflow. The feature 408 may also be detected as an alternative to the workflow 434. The feature 408 may simplify operations to achieve an end result of the workflow 434. The inference engine 424 may further automate a presentation of the content 416 by analyzing past user actions 432 to detect an underutilization or a failure to use the feature 408 (by the user). As a result, the content 416 that matches the feature 408 may be searched, located, and provided for a presentation in the teaching UI 414.

The inference engine 424 may further decide when to have a rendering engine provide the teaching UI to the productivity application. In an example scenario, the teaching UI may be provided upon a conclusion of the user action. The teaching UI may also be provided for a presentation in proximity to a section within the productivity application where the user action may conclude. The section (of the productivity application) to display the teaching UI 414 may be selected to keep the user focused on where the user action concludes. The content 416 may also include multiple steps such as a step A 436 and a step B 438 that describe how to use the feature 408.

Furthermore, the past user actions 432 may be processed to detect an error 430 associated with a utilization of the feature 408. The error 430 may include a number of scenarios such as a wrong utilization of the feature 408, and/or an incomplete utilization of the feature 408, among others. The inference engine 424 may detect a number of the error 430 and other errors associated with the utilization of the feature 408 by the user at the productivity application. If the number of the errors exceed a threshold value then the content 416 may be redisplayed on the teaching UI 414 to retrain the user. Alternatively, a section of the content 416 may also be provided that addresses the error 430 and other errors that address the missteps by the user while utilizing the feature 408. The threshold value used to compare the number of errors may be dependent on an optimum utilization of the feature 408. The optimum utilization of the feature 408 may be a standard (configured in the productivity service 402) that meets use expectations of a consumer of the productivity application or a creating/deploying entity associated with the productivity application.

Furthermore, the past user actions 432 associated with the productivity application and other productivity applications may be analyzed to detect underutilization or a failure to use the feature 408 by the user. In such a scenario, the content may be provided to the user through the teaching UI 414. Alternatively, the past user actions 432 may be analyzed to detect an intent by the user to not use the feature 408 in the productivity application and/or other productivity applications. In such a scenario, the inference engine 424 may prevent an automated presentation of the content 416 through the teaching UI 414.

As discussed above, the productivity service may be employed to provide a teaching UI activated by a user action. An increased user efficiency with the productivity service 102 may occur as a result of processing a user action and a user trait to match a feature of the productivity application to a training content. Additionally, automated training of the user 110 on demand with training content (that describes how to use the feature) by the productivity service 102, may reduce processor load, increase processing speed, conserve memory, and reduce network bandwidth usage.

Embodiments, as described herein, address a need that arises from a lack of efficiency to provide a teaching UI activated by a user action. The actions/operations described herein are not a mere use of a computer, but address results that are a direct consequence of software used as a service offered to large numbers of users and applications.

The example scenarios and schemas in FIG. 1 through 4 are shown with specific components, data types, and configurations. Embodiments are not limited to systems according to these example configurations. Providing a teaching UI activated by a user action may be implemented in configurations employing fewer or additional components in applications and user interfaces. Furthermore, the example schema and components shown in FIG. 1 through 4 and their subcomponents may be implemented in a similar manner with other values using the principles described herein.

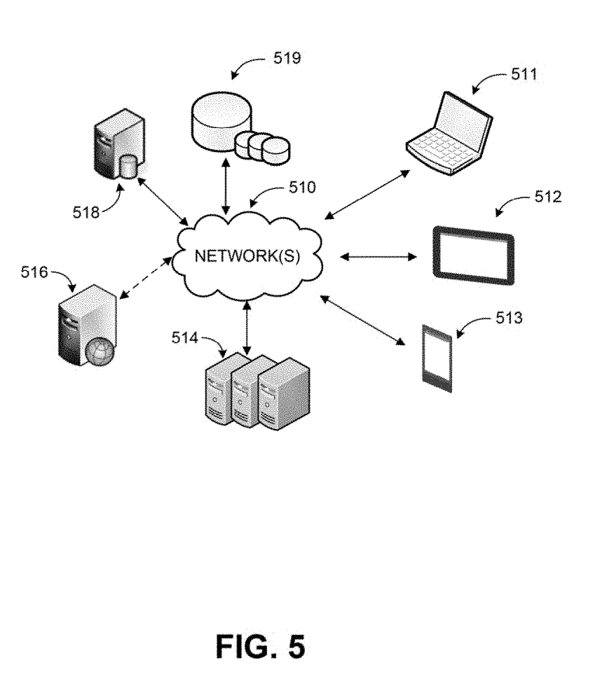

FIG. 5 is an example networked environment, where embodiments may be implemented. A productivity service configured to provide a teaching UI activated by a user action may be implemented via software executed over one or more servers 514 such as a hosted service. The platform may communicate with client applications on individual computing devices such as a smart phone 513, a mobile computer 512, or desktop computer 511 (‘client devices’) through network(s) 510.

Application(s) executed on any of the client devices 511-513 may facilitate communications via service(s) executed by servers 514, or on individual server 516. A productivity service may receive a notification of a user action from a productivity application. The productivity service may recognize a trait associated with a user performing the user action. A content associated with a feature may be identified for a presentation in a teaching UI based on the trait and the user action. Next, the content may be provided for the presentation in the teaching UI. The productivity service may store data associated with the feature in data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to provide a teaching UI activated by a user action. Furthermore, the networked environments discussed in FIG. 5 are for illustration purposes only. Embodiments are not limited to the example applications, modules, or processes.

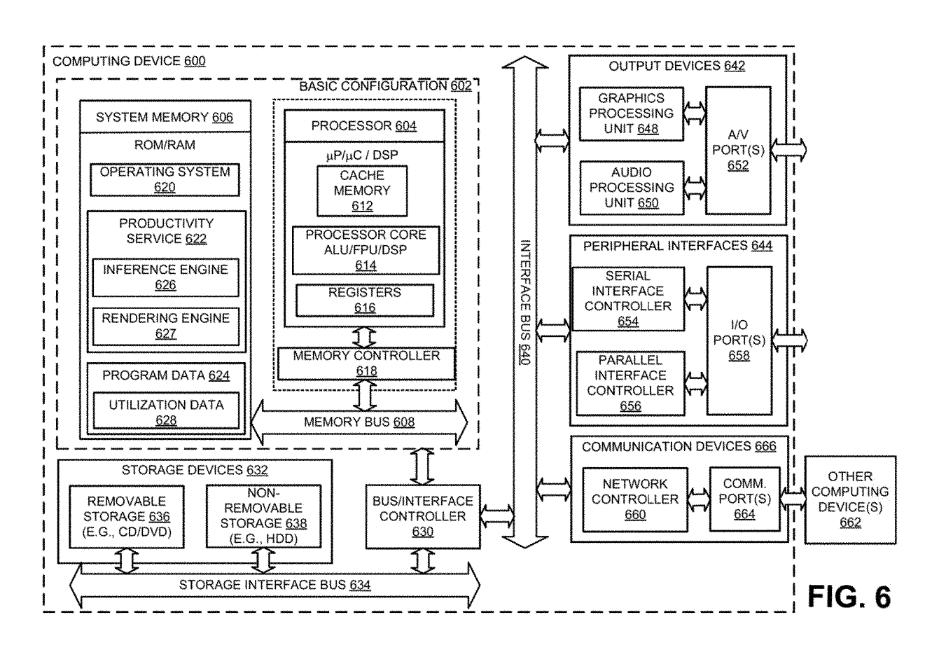

FIG. 6 is a block diagram of an example computing device, which may be used to provide a teaching UI activated by a user action, according to embodiments.

For example, computing device 600 may be used as a server, desktop computer, portable computer, smart phone, special purpose computer, or similar device. In an example basic configuration 602, the computing device 600 may include one or more processors 604 and a system memory 606. A memory bus 608 may be used for communication between the processor 604 and the system memory 606. The basic configuration 602 may be illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, one or more processor cores 614, and registers 616. The example processor cores 614 may (each) include an arithmetic logic unit (ALU), a floating point unit (FPU), a digital signal processing core (DSP Core), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a productivity service 622, and a program data 624. The productivity service 622 may include components such as an inference engine 626 and a rendering engine 627. The inference engine 626 and the rendering engine 627 may execute the processes associated with the productivity service 622. The inference engine 626 may receive a notification of a user action from a productivity application. The inference engine 622 may recognize a trait associated with a user performing the user action. A content associated with a feature may be identified for a presentation in a teaching UI based on the trait and the user action. The rendering engine 627 may provide the content in the teaching UI for the presentation on the productivity application.

The productivity service 622 may communicate with the productivity application through communication device(s) 666 of the computing device 600. The communications between the productivity service 622 and the productivity application may include program data 624. The program data 624 may include, among other data, utilization data 628, or the like, as described herein. The utilization data 628 may include the feature, the content, the user action, and/or the attribute of the user, among others.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDDs), optical disk drives such as compact disk (CD) drives or digital versatile disk (DVD) drives, solid state drives (SSDs), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 666) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example of the communication device(s) 666 includes a network controller 660, which may be arranged to facilitate communications with one or more other computing devices 662 over a network communication link via one or more communication ports 664. The one or more other computing devices 662 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer, which includes any of the above functions. The computing device 600 may also be implemented as a personal computer including both laptop computer and non-laptop computer configurations.

Example embodiments may also include methods to provide a teaching UI activated by a user action. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

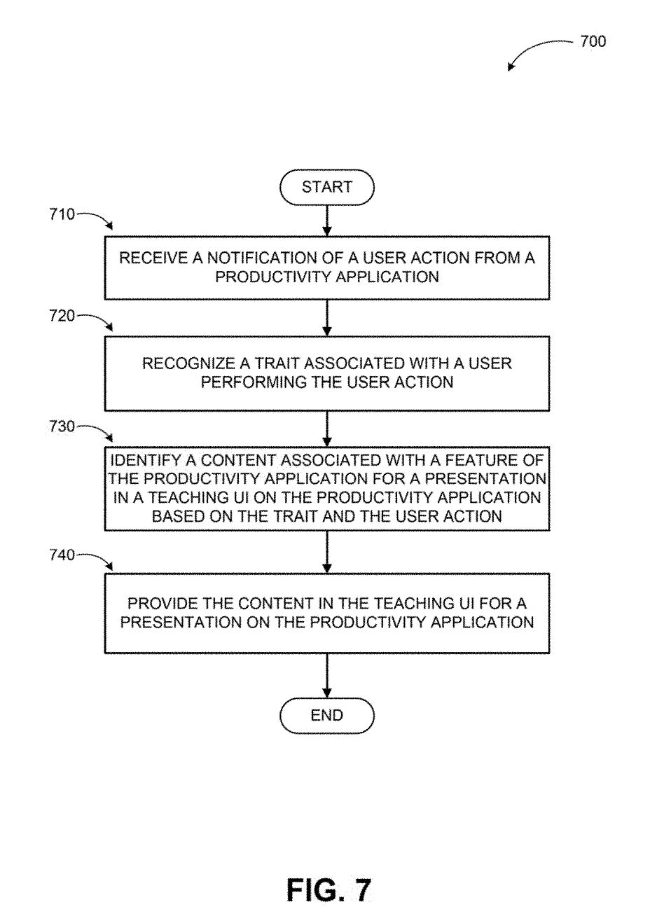

FIG. 7 is a logic flow diagram illustrating a process for providing a teaching U activated by a user action, according to embodiments. Process 700 may be implemented on a computing device, such as the computing device 600 or another system.

Process 700 begins with operation 710, where the productivity service receives a notification of a user action from a productivity application. At operation 720, a trait associated with a user performing the user action may be recognized. The trait may include a credential of the user, a context associated with the user, and/or similar ones.

At operation 730, a content associated with a feature of the productivity application may be identified for a presentation in a teaching UI on the productivity application based on the trait and the user action. The feature may include a new or existing feature (with or without updates). The user may be selected for training on how to use the feature if the feature is determined to be underutilized or in demand by the user. The content may include a video stream (among other modalities) that provides instructions on how to use the feature. At operation 740, the content may be provided in the teaching UI for a presentation on the productivity application.

The operations included in process 700 is for illustration purposes. Providing a teaching UI activated by a user action may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

In some examples, a physical server to provide a teaching user interface (UI) activated by a user action is described. The physical server includes a memory configured to store instructions associated with a productivity service and processor(s) coupled to the memory. The processor(s) execute the productivity service in conjunction with the instructions stored in the memory. The productivity service includes an inference engine and a rendering engine. The inference engine is configured to receive a notification of a user action from a productivity application, recognize a trait associated with a user performing the user action, identify a content associated with a feature of the productivity application for a presentation in a teaching UI on the productivity application based on the trait and the user action. The rendering engine is configured to provide the content in the teaching UI for a presentation on the productivity application.

In other examples, the inference engine is further configured to match the trait and the user action to the feature of the productivity application and locate the content that describes the feature of the productivity application. The inference engine is further configured to detect a credential of the user as the trait associated with the user. The inference engine is further configured to query a provider with the credential for a context associated with the user, wherein the context includes one or more of a role of the user within an organization, an expertise of the user with the productivity application, a training history of the user with the productivity application, a utilization history of the user with the productivity application, receive the context associated with the user from the provider, and search, and locate the content that matches the feature and the context associated with the user.

In further examples, the inference engine is further configured to retrieve a use history of the productivity application by the user with the credential, analyze the use history to identify the feature of the productivity application underutilized by the user, and identify the content that matches the feature of the productivity application. The inference engine is further configured to retrieve a use history of the productivity application by the user with the credential, analyze the use history to identify the feature of the productivity application that is previously unused by the user, and identify the content that matches the feature of the productivity application.

In other examples, the inference engine is further configured to analyze the user action to detect an intent of the user to activate the feature of the productivity application, search the content that matches the feature, and locate the content that matches the feature. The inference engine is further configured to analyze a use history associated with the feature to detect an underutilization or a failure to use the feature by the user and provide the content to the rendering engine for a presentation to the user. The inference engine is further configured to analyze the user action to detect a workflow of the user within the productivity application and detect the feature of the productivity application associated with the workflow. The inference engine is further configured to analyze one or more past user actions to detect an underutilization or a failure to use the feature by the user, search and locate the content that matches the feature, and provide the content to the rendering engine for a presentation to the user. The inference engine is further configured to provide the teaching UI for the presentation in proximity to a section within the productivity application associated with a conclusion of the user action.

In some examples, a method executed on a computing device to provide a teaching user interface (UI) activated by a user action is described. The method includes receiving a notification of the user action from a productivity application, recognizing a trait associated with a user performing the user action, matching the trait and the user action to a feature of the productivity application, searching and locating a content that describes the feature of the productivity application, and providing the content in a teaching UI for a presentation on the productivity application.

In other examples, the content includes one or more steps that illustrate how to use the feature. The method further includes processing one or more past user actions associated with the feature to detect one or more errors associated with a utilization of the feature and detecting a number of the one or more errors exceed a threshold value associated with an optimum utilization of the feature. The method further includes in response to matching the one or more errors to a section of the content, providing the section of the content in the teaching UI for the presentation to the user and in response to matching the one or more errors to two or more sections of the content, reloading the content in the teaching UI for another presentation to the user.

In further examples, the method further includes querying one or more other productivity applications to detect underutilization or a failure to use the feature on the one or more other productivity applications by the user, analyzing a workflow of the user action to identify a potential to enhance the workflow with the feature, and providing the content for a presentation to the user. The method further includes analyzing one or more past actions by the user on one or more other productivity applications to detect an intent by the user to not use the feature, wherein the one or more other productivity applications include the feature and preventing the presentation of the content to the user.

In some examples, a computer-readable memory device with instructions stored thereon to provide a teaching user interface (UI) activated by a user action is described. The instructions include operations that are similar to operations of the method.

In some examples, a means for providing a teaching user interface (UI) activated by a user action is described. The means for providing a teaching user interface (UI) activated by a user action includes a means for receiving a notification of a user action from a productivity application, a means for recognizing a trait associated with a user performing the user action, a means for identifying a content associated with a feature of the productivity application for a presentation in a teaching UI on the productivity application based on the trait and the user action, and a means for providing the content in the teaching UI for a presentation on the productivity application.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A physical server to provide a teaching user interface (UI) activated by a user action, the physical server comprising:
a memory configured to store instructions associated with a productivity service;
one or more processors coupled to the memory, the one or more processors executing the productivity service in conjunction with the instructions stored in the memory, wherein the productivity service includes:
an inference engine configured to:
receive a notification of a user action from a productivity application;
recognize a trait associated with a user performing the user action;
identify a content associated with a feature of the productivity application for a presentation in a teaching UI on the productivity application based on the trait and the user action; and
a rendering engine configured to:
provide the content in the teaching UI for a presentation on the productivity application.

2. The physical server of claim 1, wherein the inference engine is further configured to:
match the trait and the user action to the feature of the productivity application; and
locate the content that describes the feature of the productivity application.

3. The physical server of claim 1, wherein the inference engine is further configured to:
detect a credential of the user as the trait associated with the user.

4. The physical server of claim 3, wherein the inference engine is further configured to:
query a provider with the credential for a context associated with the user, wherein the context includes one or more of a role of the user within an organization, an expertise of the user with the productivity application, a training history of the user with the productivity application, a utilization history of the user with the productivity application;
receive the context associated with the user from the provider; and
search and locate the content that matches the feature and the context associated with the user.

5. The physical server of claim 3, wherein the inference engine is further configured to:
retrieve a use history of the productivity application by the user with the credential;
analyze the use history to identify the feature of the productivity application underutilized by the user, and
identify the content that matches the feature of the productivity application.

6. The physical server of claim 3, wherein the inference engine is further configured to:
retrieve a use history of the productivity application by the user with the credential;
analyze the use history to identify the feature of the productivity application that is previously unused by the user; and
identify the content that matches the feature of the productivity application.

7. The physical server of claim 1, wherein the inference engine is further configured to:
analyze the user action to detect an intent of the user to activate the feature of the productivity application;
search the content that matches the feature; and
locate the content that matches the feature.

8. The physical server of claim 7, wherein the inference engine is further configured to:
analyze a use history associated with the feature to detect an underutilization or a failure to use the feature by the user; and
provide the content to the rendering engine for a presentation to the user.

9. The physical server of claim 1, wherein the inference engine is further configured to:
analyze the user action to detect a workflow of the user within the productivity application; and
detect the feature of the productivity application associated with the workflow.

10. The physical server of claim 9, wherein the inference engine is further configured to:
analyze one or more past user actions to detect an underutilization or a failure to use the feature by the user;
search and locate the content that matches the feature; and
provide the content to the rendering engine for a presentation to the user.

11. The physical server of claim 1, wherein the rendering engine is further configured to:
provide the teaching UI for the presentation in proximity to a section within the productivity application associated with a conclusion of the user action.

12. A method executed on a computing device to provide a teaching user interface (UI) activated by a user action, the method comprising:
receiving a notification of the user action from a productivity application;
recognizing a trait associated with a user performing the user action;
matching the trait and the user action to a feature of the productivity application;
searching and locating a content that describes the feature of the productivity application; and
providing the content in a teaching UI for a presentation on the productivity application.

13. The method of claim 12, wherein the content includes one or more steps that illustrate how to use the feature.

14. The method of claim 12, further comprising:
processing one or more past user actions associated with the feature to detect one or more errors associated with a utilization of the feature; and
detecting a number of the one or more errors exceed a threshold value associated with an optimum utilization of the feature.

15. The method of claim 14, further comprising:
in response to matching the one or more errors to a section of the content, providing the section of the content in the teaching UI for the presentation to the user; and
in response to matching the one or more errors to two or more sections of the content, reloading the content in the teaching UI for another presentation to the user.

16. The method of claim 12, further comprising:
querying one or more other productivity applications to detect underutilization or a failure to use the feature on the one or more other productivity applications by the user;
analyzing a workflow of the user action to identify a potential to enhance the workflow with the feature; and
providing the content for a presentation to the user.

17. The method of claim 12, further comprising:
analyzing one or more past actions by the user on one or more other productivity applications to detect an intent by the user to not use the feature, wherein the one or more other productivity applications include the feature; and
preventing the presentation of the content to the user.

18. A computer-readable memory device with instructions stored thereon to provide a teaching user interface (UI) activated by a user action, the instructions comprising:
receiving a notification of a user action from a productivity application;
recognizing a trait associated with a user performing the user action;
matching the trait and the user action to a feature of a productivity application;
searching and locating a content that describes the feature of the productivity application, wherein the content includes one or more steps that illustrate how to use the feature; and
providing the content in a teaching UI for a presentation on the productivity application.

19. The computer-readable memory device of claim 18, wherein the instructions further comprise:
detecting a credential of the user as the trait associated with the user,
retrieving a use history of the productivity application by the user with the credential;
analyzing the use history to identify the feature of the productivity application underutilized or not used by the user; and
identify the content that matches the feature of the productivity application.

20. The computer-readable memory device of claim 18, wherein the instructions further comprise:
processing one or more past user actions associated with the feature to detect one or more errors associated with a utilization of the feature:
detecting a number of the one or more errors exceed a threshold value associated with an optimum utilization of the feature; and
in response to matching the one or more errors to a section of the content, providing the section of the content in the teaching UI for the presentation to the user.
